(19) United States
(12) Patent Application Publication
(10) Pub. No.: US 2025/0376648 A1
(43) Pub. Date: Dec. 11, 2025

(54) PROCESS FOR MAKING WATER-SOLUBLE POUCHES

(71) Applicant: The Procter & Gamble Company, Cincinnati, OH (US)

(72) Inventors: Qiuyang HE, Beijing (CN); Yanjie WENG, Beijing (CN); Zhen LIU, Beijing (CN)

(21) Appl. No.: 19/234,444

(22) Filed: Jun. 11, 2025

(30) Foreign Application Priority Data
Jun. 11, 2024 (WO) PCT/CN2024/098404

(51) Int. Cl. C11D 17/04; B29C 65/00; B29C 65/14; B29C 65/48; B29L 31/00; B65B 3/02; B65B 51/02; B65B 51/16; B65B 61/06; B65D 65/46; B65D 75/32; B65D 75/48

(52) U.S. Cl. CPC C11D 17/045; B29C 65/1429; B29C 65/4895; B29C 66/022; B29C 66/0326; B29C 66/5326; B29C 66/731; B65B 3/022; B65B 51/02; B65B 51/16; B65B 61/06; B65D 65/46; B65D 75/323; B65D 75/48; B29K 2995/0062; B29L 2031/7128

(57) ABSTRACT

A process for making water-soluble pouches having at least one compartment on a sealing plane is disclosed. The process is characterized by the difference in the first water-soluble film heating temperature and the second water-soluble film heating temperature being reduced substantially. The resulting water-soluble pouch comprises of almost symmetrically shaped individual compartments relative to the sealing plane respectively and optionally with different depth of each compartment enabling stereoscopic and contemporary appearance to the consumer.

### FIELD OF THE INVENTION

The present invention generally relates to a process for making water-soluble pouches. More particularly, the invention relates to water-soluble pouches, optionally having multiple compartments with varying depths, having a symmetrical shape of a first and second water-soluble films of each compartment relative to the sealing plane.

### BACKGROUND OF THE INVENTION

Water-soluble pouches have gained significant traction in various industries, particularly in the realm of household cleaning products and personal care items. These pouches offer convenient and precise dosing while minimizing direct contact with potentially harmful substances. Water soluble pouches for delivering substrate treatment agents, such as dishwashing detergents, laundry detergents, and surface cleaning compositions, are increasing in popularity globally. Typically, the consumer places the pouch in a compartment in the dishwashing machine or in the drum of a fabric washing machine or bucket of water, the pouch is exposed to water, and the pouch dissolves and releases the treatment agent.

Unitized doses of dishwashing detergents or washing machine detergents are found to be more attractive and convenient to most consumers these days, because they avoid the need of the consumer to measure the product thereby giving rise to a more precise dosing and avoiding wasteful overdosing or under dosing. The ease in the use by avoiding spillage or wastage is also one of the major reasons why consumers are attracted to using unit dose water-soluble pouches. Detergent products particularly, in pouch form are known in the art, they have the advantage over tablets, liquids and powders of avoiding the contact of the consumer fingers with the washing composition which may contain bleach and/or other irritant substances. Water soluble pouches can have many uses, as afore stated, for instance as unitary doses for laundry washing machines or for dishwashing. The process of production of such mono and multiple compartment pouches is also well described in the literature.

Conventionally, water-soluble pouches have been manufactured using processes involving the formation of a single compartment or multiple compartments arranged side by side. However, existing methods often encounter limitations regarding the uniformity of the top and bottom films, compartment heights and the symmetry of the double films within each compartment.

Existing methods typically involve feeding water-soluble film onto a continuously moving surface, forming open pouches through heating and vacuum application, filling these pouches with detergent formulations, sealing them with a second water-soluble film, and finally cutting them into individual pouches. While effective in producing water-soluble pouches, these methods frequently result in pouches with compartments of asymmetrically positioned double films or first and second water-soluble films within each compartment relative to the sealing plane.

Most commonly existing processes often yield water-soluble pouches with compartments of the same height. This uniformity restricts the versatility, aesthetics and functionality of the pouches, especially in applications requiring varying dosages or ingredient separation. Specifically, such water-pouches when side-viewed by an end-user or consumer appear to be flat like a plate, for ex., with a clear height difference above versus below or first versus the second water-soluble film with respect to the sealing plane for every compartment. The non-symmetry of these films within each compartment hinders the aesthetics, effectiveness of certain formulations, film solubility, uniform-film thickness or applications that require symmetric distribution or release of contents. This limitation restricts the scope of applications for water-soluble pouches and may necessitate additional processing steps to achieve desired symmetry. The inability to customize compartment heights/depth and film symmetry within each compartment of the pouch limits the versatility and adaptability of water-soluble pouches to meet diverse consumer needs and industry requirements.

To this end, there exists a need for an alternate, more efficient and improved process for manufacturing water-soluble pouches that addresses the challenges of asymmetric double films relative to the sealing plane, including for uniform and non-uniform compartment height and while enabling aesthetics, greater customization and versatility in water-soluble pouch design. Such advancements would enhance the functionality, efficiency, and applicability of water-soluble pouches across various sectors, including but not limited to household cleaning, personal care, and industrial applications.

The present invention provides a process for making water-soluble pouches having a single compartment or a plurality of compartments arranged in a side-by-side manner on a sealing plane, which is preferably having symmetrically shaped water-soluble films in each compartment relative to the sealing plane. Particularly, the process allows great flexibility in film size used, pouch with varying compartment sizes, pouches shape aesthetics, lesser residue of soluble film post washing without impacting much on the overall output of the pouch making process.

### SUMMARY OF THE INVENTION

A first aspect of the present invention is a process for making a water-soluble pouch having at least one compartment on a sealing plane, the process comprising the steps of:
a) feeding a first water-soluble film onto a horizontal or non-horizontal portion of a continuously and rotatably moving endless surface, which comprises a plurality of moulds, and continuously moving the film to said horizontal or non-horizontal portion;
b) heating the first water-soluble film to a first water soluble film heating temperature and forming from the first heated water-soluble film on the horizontal or non-horizontal portion of the continuously moving surface, and in the moulds on the surface, a continuously moving, horizontally or non-horizontally positioned web of open pouches, by applying an under pressure;
c) filling the continuously moving, horizontally or non-horizontally positioned web of open pouches with a formulation, to obtain a web of open and filled pouches;
d) heating a second water-soluble film to a second water-soluble film heating temperature and continuously sealing the web of open pouches, by feeding the second heated water-soluble film onto the horizontally or non-horizontally positioned web of open, filled pouches, to obtain a web of closed pouches;
   wherein at the point of sealing, the first water-soluble film heating temperature and the second water-soluble film heating temperature difference is in the range from 0 to 50° C., and the under pressure on the first film is released post the sealing of the second film, and;
e) cutting the web of closed pouches into a plurality of individual pouches.

A second aspect of the present invention is a water-soluble pouch for treatment of a substrate defining at least one internal compartment and a cleaning composition comprised within said compartment, wherein the internal compartment comprises a first water-soluble film and a second water-soluble film shaped symmetrical or substantially symmetrical relative to a sealing plane, wherein the respective internal compartments are substantially of different depth.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or re-designing, and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE DRAWINGS

FIG. 1 illustrates a water-soluble pouch according to the present invention.

FIG. 2 illustrates a water-soluble pouch according to the present invention.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

As used in this specification and the claims, the terms “comprising,” “containing,” or “including” mean that at least the named compound, element, material, particle, or method step is present in the composition, the article, or the method, but does not exclude the presence of other compounds, elements, materials, particles, or method steps even if the other such compounds, elements, materials, particles, or method steps have the same function as that which is named, unless expressly excluded in the claims. It is also to be understood that the mention of one or more method steps does not preclude the presence of additional method steps before or after the combined recited steps or intervening method steps between those steps expressly identified.

Moreover, it is also to be understood that the lettering of process steps or ingredients is for identifying discrete activities or ingredients and the recited lettering can be arranged in any sequence, unless expressly indicated.

For the purpose of the present description and of the claims which follow, except where otherwise indicated, numbers expressing amounts, quantities, percentages, and so forth, are to be understood as being modified by the term “about”. Also, ranges include any combination of the maximum and minimum points disclosed and include any intermediate ranges therein, which may or may not be specifically enumerated herein.

Wherever possible, the same reference numbers will be used throughout the drawings to refer to the same or the like parts. Embodiments disclosed herein are related to a water-soluble pouch, a process for producing the same and particularly such a pouch having at least one internal compartment with substantially symmetrical shape, according to the teachings of the present disclosure.

As used herein the term ‘water-soluble pouch’, refers to a pouch comprising mono or multiple compartments with a top and bottom water-soluble film, and each compartment comprising a liquid or powder or gel formulation for treating a substrate.

As used herein the phrase ‘first water-soluble film’ or ‘bottom film’ can be used interchangeably, refers to inner layer of the pouch, the one that holds the cleaning agents or detergent. The bottom film is made of a water-soluble material, allowing it to dissolve along with the top film during a substrate treatment process. It keeps the cleaning agents contained until the pouch is exposed to water, at which point it breaks down, releasing the contents into the washing machine or any cleaning equipment. It is to be understood that the bottom film is a first water-soluble film that is fed into a rotatably moving endless surface.

As used herein the phrase ‘second water-soluble film’ or ‘top film’ can be used interchangeably, refers to the outermost layer of the pouch, the one that is exposed to the environment when the pouch is placed in the washing machine or cleaning equipment. The top film is usually made of a water-soluble material, often PVA (polyvinyl alcohol) or a similar substance, that dissolves quickly when it comes into contact with water. This film encapsulates the cleaning agents or detergent contained within the pouch. It is to be understood that the top film is a second water-soluble film that is fed into a rotatably moving endless surface, after filling the first water-soluble film with a formulation.

As used herein the term ‘sealing plane’ refers to the edges of the top and bottom films joined together securely to form a pouch. This seal ensures that the cleaning agents are contained within the pouch until it is placed in the washing machine or cleaning equipment. The sealing plane essentially forms the boundary of the pouch, ensuring that the cleaning agents are effectively contained until they are needed during the washing cycle.

As used herein the phrase ‘first water-soluble heating temperature’ refers to the pre-heating temperature of the bottom film essentially, prior to deformation of the film. Similarly, the phrase ‘second water-soluble heating temperature’ refers to the heating temperature of the top film essentially, at the point of sealing. It is to be understood here that the said temperatures do not relate to the device or the apparatus heating temperature, and are essentially respective film temperatures only.

As used herein the term ‘compartment’ in a water-soluble pouch refers to each compartment typically containing a cleaning agent, fabric softener, stain remover or bleach. The compartment should be understood as meaning a closed internal space within the water-soluble pouch, which holds the aforesaid formulation(s). During manufacture, a first water-soluble film may be shaped to comprise an open compartment into which the composition is added. A second water-soluble film is then laid over the first film in such an orientation as to close the opening of the compartment. The first and second films are then sealed together along a seal region.

As used herein, the terms “side-by-side manner” means the first compartment, the second compartment and optionally third or subsequent compartments are arranged next to each other on a sealing plane.

As used herein the phrase ‘symmetrical shaped’ or “substantially symmetrical shaped” in each compartment refers to any individual compartment having top and bottom films that are identical or almost identical in shape and size relative to the sealing plane, creating a uniform appearance of the top and bottom films respectively.

As used herein the terms ‘different depth’ or ‘different height’ or ‘non-uniform depths and height’ can be used interchangeably, refer to the compartments in the water-soluble pouch having a depth difference in every compartment leading to non-uniform appearance of water-soluble pouch comprising multiple compartments or different heights of each compartment.

In one aspect, the present disclosure provides a process for making a water-soluble pouch having at least one compartment, and more particularly a plurality of compartments arranged in a side-by-side manner on a sealing plane. The process in accordance with the present disclosure is characterized by the water-soluble pouches resulting in symmetrically or substantially symmetrically shaped individual compartments respectively, achieved by optimizing process parameters. Beneficially, the process for making water-soluble pouches as per the present disclosure has aided the end-user/consumer in terms of aesthetically pleasing pouches, including the option of providing a water-soluble pouch with different depth of each compartment enabling stereoscopic and contemporary appearance to the water-soluble pouch. Furthermore, beneficially, the process for making water-soluble pouches has enabled reduced film residue at the end of a wash cycle process. Furthermore, beneficially, the process of making water-soluble pouches enabled great flexibility/stretchability in film size, multi compartment pouches with different sizes, and economically significant and simple process, without impacting much on the overall output of the pouch making process.

In accordance with a first aspect of the present invention, a process for making a water-soluble pouch having at least one compartment on a sealing plane is provided. Preferably the process allows for making the water-soluble pouch comprising a plurality of compartments (for ex., at least two compartments) arranged in a side-by-side manner on a sealing plane. The process comprises of feeding a first water-soluble film onto a horizontal or non-horizontal portion of a continuously and rotatably moving endless surface, which comprises a plurality of moulds, and continuously moving the film to said horizontal or non-horizontal portion.

As used herein, ‘endless surface’ means that the surface is endless in one dimension at least. For example, the surface is preferably part of a rotating platen conveyer belt or chain comprising moulds. Without wishing to be bound by theory, there may be gaps between the moulds on the belt/chain. The moulds may be positioned onto platens (each platen comprising one or more moulds) and these platens may have gaps between one another. Accordingly, the present invention involves continuously feeding a first water-soluble film onto an endless surface (for ex., a platen conveyer belt), preferably onto a horizontal portion of an endless surface, or otherwise, on a non-horizontal portion of this surface. In some embodiments the first water-soluble film may be fed directly onto the non-horizontal portion. In a preferred embodiment the first water-soluble film is fed directly onto the horizontal portion.

In accordance with the process of the present invention, the horizontal or non-horizontal portion of the surface can vary in width, generally determined by the number of lanes of moulds across its width, the size of the moulds, and the necessary spacing between them. The length of this portion can also vary, typically based on the number of process steps needed on this part of the surface, the time required for each step, and the optimal speed of the surface for these steps.

In a preferred embodiment of the present invention, the first water-soluble film is further heated to a first water-soluble film heating temperature and subsequently forming from the first heated water-soluble film on the horizontal or non-horizontal portion of the continuously moving surface, and in the moulds on the surface, a continuously moving, horizontally or non-horizontally positioned web of open pouches, by applying an under pressure. The first water-soluble heating temperature is achieved by heating the bottom film before being drawn into the moulds and then drawing the bottom film under a first pressure to form a recess or plurality of recesses. Alternatively, the first water-soluble film can be drawn down into the moulds preferably with the help of vacuum or blown down under pressure into the mould and heated to the thermoforming temperature to mould the bottom film onto the moulds (this process either with or without vacuum or pressure is referred herein as thermo-forming) to form a recess or plurality of recesses.

Preferably, a first under pressure ranging between 200 mbar to 900 mbar is applied to the moulds after the first water-soluble film is heated and positioned over the moulds. More preferably a first under pressure ranging between 200 mbar to 800 mbar, yet more preferably under pressure ranging between 225 mbar to 700 mbar, most preferably 250 mbar to 500 mbar, for ex., 300 mbar, 350 mbar, 400 mbar or any ranges there between is applied to the moulds.

In an embodiment at least two different under-pressures comprising a first under-pressure and a second under-pressure is applied to moulds. Preferably, the at least two different under-pressures correspond to at least two sections of the infrared lamp. More preferably, a first section of the infrared lamp is configured to heat the first water-soluble film to a first temperature after the first water-soluble film is fed onto the conveyer and a first under-pressure is applied to the moulds after the first water-soluble film is heated by the first section of the infrared lamp, and a second section of the infrared lamp is configured to heat the first water-soluble film to a second temperature after the first water-soluble film moves to the second section on the conveyer and a second under-pressure is applied to the moulds after the first water-soluble film is heated by the second section of the infrared lamp. Preferably, the first under-pressure is from greater than 0 mbar to 200 mbar, preferably between 10 and 100 mbar, and the second under-pressure is as described before.

In some embodiments, the web of open pouches can be created using thermoforming, which may involve heating the moulds or applying heat through methods like blowing hot air or using heating lamps. Vacuum assistance can be used if needed to help shape the film into the mould. Alternatively, open pouches can be formed through vacuum-forming, with optional heat assistance to aid the process. Within the process according to the invention preferably the open pouches are formed with heat assistance. Generally, thermoforming is primarily a plastic deformation process, while vacuum-forming is mainly an elastic deformation process. These two techniques can be combined to produce pouches with any desired balance of elasticity and plasticity.

Accordingly, the open pouches can be formed in the moulds by any method, and as described above, preferred methods include the use of (at least) a vacuum or under-pressure to draw the film into the moulds. Other preferred methods involve heating the film to make it more flexible or stretched so that it conforms to the shape of the mould. This can be combined with applying a vacuum or under-pressure to pull the film into the moulds, or using a combination of these techniques. The first water-soluble film can be drawn into the moulds using a vacuum or under-pressure and preferably kept in place within the moulds on the belt by vacuum or under-pressure. Specifically, the vacuum or under-pressure may be applied through holes in the moulds, which can be arranged in any suitable pattern. One or more holes (e.g. 2, 3, 5, 10, 100 or 1000) may be arranged in each mould. The holes may be in any shape, preferably circular. Particularly, the holes may be sized such that at the temperature of deformation, plastic deformation or thermoforming, the water-soluble film is not pulled into the holes to such an extent that the structural integrity of the finished pouch is compromised.

The moulds may have a chamfered edge (e.g. with 45 degrees) or rounded edge. Such a configuration may help to prevent weak point creation near corners. The moulds may be made from aluminum which may preferably have a protective anodization treatment to prevent corrosion. The moulds can have any shape, length, width and depth, depending on the required dimensions of the pouches. Per surface, the moulds can also vary of size and shape from one to the other, if desirable. For example, it may be preferred that the volume of the final pouches is between 5 and 300 ml, or even 10 and 150 ml, e.g. 10 ml, 12 ml, 15 ml, 20 ml and that the mould sizes are adjusted accordingly.

The conveyor and/or the platens may further comprise a plurality of apertures which are located at both edges of the conveyor and/or the platens along the machine direction, in which vacuum or an under-pressure may be applied through the plurality of apertures. The vacuum or under-pressure applied to the plurality of apertures may help to hold the side edges of the first water-soluble film to the side margins of the conveyor and/or the platens. Particularly, the apertures may be sized such that at the temperature of deformation, plastic deformation or thermoforming, the water-soluble film is not pulled into the apertures to such an extent that the structural integrity of the resulting water-soluble pouch is compromised.

Preferably, the platen conveyer is capable of continuously moving in horizontal position, until the platen conveyer rotates around an axis perpendicular to the direction of motion, preferably about 180 degrees, to then move in opposite direction which is in a horizontal motion.

The plurality of moulds may be arranged in an array having 2 to 20, preferably 3 to 15, moulds in the direction of width and 1 to 10, preferably 2 to 5, moulds in the direction of length.

Alternatively, the endless surface may be discrete platens moving on a magnetic conveyor (e.g. Rockwell's iTrack). Then preferably, the surface can be removed and replaced with another surface having other dimensions or comprising moulds of a different shape or dimension. This allows for the usage for the production of different types of pouches. This may for example be a belt having a series of platens, whereof the number and size will depend on the length of the horizontal portion and diameter of turning cycles of the surface, for example having 30 to 200, for example, 50, 70, 90, 120, 150 or any ranges there between, for example each having a length (direction of motion of platen and surface) of 4 to 50 cm, for example, 4, 5, 10, 15, 20, 30, 40, 50 cm or any ranges there between.

The surface, or typically the belt or chain connected to the surface, can be continuously moved by use of any known method. Preferred is the use of a zero-elongation chain system, to which the individual platens/moulds are attached.

In a further preferred embodiment, heat can be applied by any means, for example directly, by contact heating (e.g. running the film over a heated roller), passing the film under a heating element or through hot air, prior to feeding it onto the surface or once on the surface, or indirectly, for example by heating the surface or applying a hot item onto the film, for example to film temperatures of 80 to 150° C., or even 90 to 120° C., preferably for example with infrared light. Any suitable IR lamps may be used, including infrared quartz tube lamps. Particularly, the temperature of the IR emitting surface in the IR lamps may be 150 to 1000° C., e.g. 200° C., 300° C., 400° C., 500° C., 700° C., 1000° C.

The first water-soluble film can be wetted by any mean, for example directly by spraying a wetting agent (including water, solutions of the film material or plasticizers for the film material) onto the film, prior to feeding it onto the surface or once on the surface, or indirectly by wetting the surface or by applying a wet item onto the film. In accordance with the present invention, the first water-soluble film is heated to its heating temperature in the range from 80 to 150° C., to make the film more flexible or even stretched, so that it adopts the shape of the mould. Preferably the first water-soluble film heating temperature of the first water-soluble film is in the range of 90 to 120° C., most preferably 100 to 120° C.

The process further comprises filling the continuously moving, horizontally or non-horizontally positioned web of open pouches with a formulation, to obtain a web of open and filled pouches, once the recess(es) are formed. In a preferred embodiment, the first open web of open pouches is filled by means of a product filling station comprising means for filling quantities of one or more product feed streams into each of the open pouches. Preferably this filling station is designed to move in sync with the first web of open pouches during the filling step, preventing any acceleration or deceleration of the pouches that could cause detergent spillage and contamination of the scaling area. The rectilinear movement of the first web of open pouches enables more complete filling, leading to better utilization of the film. Alternatively, the filling station can remain stationary.

The formulation/composition can be delivered into each of the open pouches through individual dosing or dispensing devices having a single feeder or means for supplying a single product feed stream, this being preferred in cases where a single premixed composition is to be delivered into the pouch. In the case of multi component liquid compositions, each pouch can be filled by means of multiple feeders or means for supplying a plurality of product feed streams, each feeder delivering a different liquid composition (or component thereof), so as to avoid the need for a premixing step. In the case of multi component powder compositions, again each pouch can be filled by means of multiple feeders, each one delivering a powder composition (or component thereof) so as to form distinct compartments of product. In the case of powder compositions, it is advantageous to have a masking belt having an orifice of the same size or slightly smaller than the aperture of the open pouch, in order to avoid seal contamination.

The filling of the web of open pouches while it moves rectilinear with continuous motion, can be done by any known method for filling (moving) items. The exact most preferred method depends on the product form and speed of filling required. Preferably the formulation/composition may be a liquid, powder, gel or a paste. More preferably, the formulation may be a liquid or particulate composition, mostly essentially a liquid fabric cleaning or surface cleaning composition, more preferably a liquid laundry detergent or automatic dish washing detergent.

Generally, preferred methods include continuous motion in line filling, which uses a dispensing unit with nozzles positioned above the open pouches, which typically moves reciprocately with continuous motion, whereby the nozzles move with the same speed as the pouches and in the same direction, such that each open pouch is under the same nozzle or nozzles for the duration of the dispensing step. After the filling step, the nozzles rotate and return to the original position, to start another dispensing/filling step.

Subsequently to filling of the formulation, the web of pouches is closed by placing a second water-soluble film on top of the filled recess and sealing the films together. The second water-soluble film can be wetted by any mean, for example directly by spraying a wetting agent (including water, solutions of the film material or plasticizers for the film material) onto the film, prior to feeding it onto the surface or once on the surface, or indirectly by wetting the surface or by applying a wet item onto the film.

In accordance with the present invention, the closing of the web of pouches is done by continuously feeding the second water-soluble film, over and onto the web of open pouches and then preferably sealing the first film and second film together, typically in the area between the moulds and thus between the pouches and in between the individual separate compartments of an individual pouch.

The second water-soluble film is fed onto the open pouches with the same speed and in moving in the same direction as the open pouches.

Preferably the second water-soluble film is heated to a second water-soluble film heating temperature and continuously sealing the web of open pouches, by feeding the second heated water-soluble film onto the horizontally or non-horizontally positioned web of open, filled pouches, to obtain a web of closed pouches.

The sealing process can be performed by any method. The sealing can be done discontinuously, such as by transporting the web of pouches to a different area with sealing equipment. However, it is preferably done continuously and at a constant speed, while the closed web of pouches moves continuously at a constant speed. Preferably, this sealing process occurs in a straight-line position, which can be on the horizontal or non-horizontal portion of the surface.

Preferred methods for sealing used herein is heat sealing, that can be done by any known medium, for example direct application, infra-red, ultrasonic, radio frequency, laser. Solvent sealing can alternatively be used herein. The heat or solvent can be applied by any method on the closing material. The second water-soluble film may be wetted by spraying a solvent (e.g. water) on the film or contacting a solvent-containing article (e.g. water-containing sponge) with the closing material. Preferred may be that when heat sealing is used, a roller with cavities of the size of the part of the pouch, which is not enclosed by the mould, and having a pattern of the pouches, is (continuously) rolled over the web pouches, passing under the roller. Hereby, the heated roller contacts only the area which is to be the sealing area, namely between the moulds, around the edges of the moulds. Typically sealing temperatures are from 30° C., 50° C., 70° C., 90° C., 110° C., 120° C., or any ranges there between depending on the film material of course. Most preferred method of sealing as per the invention is solvent sealing.

The second water-soluble film is heated to its heating temperature in the range from 30 to 175° C., at the sealing point, to make the film more flexible or even stretched. Preferably the second water-soluble film heating temperature of the second water-soluble film is in the range of 60 to 150° C., more preferably 80 to 140° C., most preferably 100 to 130° C.

Preferably the second water-soluble film is heated to its film temperature by using a suitable infrared lamp such as infrared quartz tube lamps, a heating plate or a combination thereof. Heat can be applied by any means, for example directly, by contact heating (e.g. running the film over a heated roller), passing the film under a heating element or through hot air, prior to feeding it onto the surface or once on the surface, or indirectly, for example by heating the surface or applying a hot item onto the film, for example to temperatures of 30 to 175° C., or even 60 to 150° C., preferably for example with infrared light. Any suitable infrared lamps may be used, including infrared quartz tube lamps. Particularly, the temperature of the IR emitting surface in the IR lamps may be 150 to 1000° C., e.g. 200° C., 300° C., 400° C., 500° C., 700° C., 1000° C.

Further in accordance with the present invention, the first water-soluble film and the second water-soluble film are sealed. Preferably at the point of sealing, the first water-soluble film heating temperature and the second water-soluble film heating temperature difference is in the range from 0 to 50° C., and the vacuum pressure on the first film is released post the sealing of the second film. More preferably the first water-soluble film heating temperature and the second water-soluble film heating temperature difference is in the range from 0 to 30° C., particularly in the range of 0 to 20° C. The first water-soluble film heating temperature and the second water-soluble film heating temperature difference in every embodiment is preferably less than 50° C. The second water-soluble film thereby gets deformed upon release of the vacuum due to the first film re-contracting then and as such pushing the enclosed formulation upwards and as such lifting and deforming the second water-soluble film upwards.

The optimized heating temperature difference between the first water-soluble film and the second water-soluble film in accordance with every embodiment of the present invention, has enabled to control the second water-soluble film relaxation/bouncing levels. In a preferred embodiment of the present invention, the first water-soluble film and the second water-soluble film heating temperature difference (difference in respective film temperatures essentially) controls both the films elasticity properties and control the second-water soluble film bouncing level. This further controls the actual water-soluble pouch appearance from side view. More particularly the scaling process is applied when the first water-soluble film is still stretched into the cavity under influence of first under pressure. As such the second water-soluble film is laid flat on top of that open cavity. Upon release of the under pressure the stretched first water-soluble film relaxes, e.g. partially recontracts, and as such a pressure is applied by the formulation on the non-deformed second water-soluble film, rendering it somewhat bulged, stretched and flexible. In accordance with the present invention, by heating the second water-soluble film to its heating temperature at the point of sealing, as the vacuum pressure is released straight after the sealing process, the second water-soluble film is more plastic/elastic hence sensitive to bulging. This mechanism leads to substantially or almost symmetrical shaped first and second water-soluble films relative to the scaling plane post deformation in the resulting pouch.

Each of the water-soluble pouches may comprise a plurality of compartments which may be preferably arranged in a manner of side-by-side. Preferably, each compartment contains a different formulation, for ex., preferably a liquid or solid cleaning composition or care composition, preferably a laundry or automatic dish washing composition, hard-surface cleaner and/or a fabric or surface care composition, such as conditioners, rinse additives, pretreatment and/or soaking compositions. The composition can be in any suitable form such as a liquid, a gel, a solid, or a particulate (compressed or uncompressed). The formulation can be made by any method and can have any viscosity, typically depending on its ingredients. The liquid/gel formulations preferably have a viscosity of 50 to 10000 cps (centipoises), as measured at a rate of 20 s⁻¹, more preferably from 100 to 3000 cps or even from 200 to 600 cps. The formulations herein can be Newtonian or non-Newtonian. The liquid formulation preferably has a density of 0.8 kg/l to 1.3 kg/l, preferably around 1.0 to 1.1 kg/l.

Preferably, as per the present invention the Top-to-Bottom depth (TBD) difference between at least two individual compartments varies essentially, for ex., the TBD is from 10% to 300%. In a most preferred embodiment, the TBD difference between at least two individual compartments is greater than 20%, 35%, 50%, or ranges there between. As used herein, the term of “Top-to-Bottom Depth Ratio” is intended to refer to the ratio of a ratio obtained by comparing the height measurements of two distinct compartments. Specifically, it is calculated by taking the height from the top to the bottom of a first compartment and the height from the top to the bottom of a second compartment, and then dividing the former by the latter. This ratio indicates the relative height difference between the two compartments.

In some embodiments, the water-soluble pouch comprises multiple compartments, wherein one said first compartment may have a footprint on the sealing plane in which the footprint is round-shaped, square-shaped, oval-shaped, triangle-shaped, rectangle-shaped, or drop-shaped. Preferably, said first compartment has a footprint on the sealing plane in which the footprint is round-shaped.

In some embodiments, the water-soluble pouch comprises multiple compartments, wherein another said second compartment may have a footprint on the sealing plane in which the footprint is donut-shaped, annular-sector-shaped, oval-shaped, crescent-shaped, leaf-shaped, or drop-shaped. Preferably, said second compartment has a footprint on the sealing plane in which the footprint is annular-sector-shaped or crescent-shaped.

In some preferred embodiments, said one or more additional compartments respectively have a footprint on the sealing plane in which the footprint is donut-shaped, annular-sector-shaped, oval-shaped, crescent-shaped, leaf-shaped, or drop-shaped. Preferably, said one or more additional compartments respectively have a footprint on the sealing plane in which the footprint is annular-sector-shaped or crescent-shaped.

The water-soluble pouch in accordance with the present invention most preferably comprises of more than at least two compartments. In every embodiment of the present invention, the depth difference between every compartment provides a stereoscopic and contemporary appearance. This allows the consumer to experience a non-uniform, yet aesthetically pleasing appearance of water-soluble pouch comprising multiple compartments or different heights of each compartment.

The water-soluble pouch comprising the plurality of compartments, produced in accordance with the disclosed method have almost symmetric first and second water-soluble films. Preferably, the ratio of height between the second water-soluble film to the sealing plane and between the first water-soluble film to the sealing plane of each compartment comprised in the resulting water-soluble pouch, as measured 24 hour after pouch making, is from 0.65 to 1.2, more preferably from 0.7 to 1.1, most preferably from 0.75 to 1, for example 0.7,0.8, 0.9, 1.0 or any ranges there between. In a most preferred embodiment the height between the second water-soluble film to the sealing plane and between the first water-soluble film to the sealing plane is essentially not same or identical amongst every compartment within a multi-compartment pouch, post deformation as measured 24 hour after pouch making.

The process further comprises cutting into individual pouches the web of at least two pouches formed in this way, for example by cutting means known per se. Preferably, the cutting of the web of closed pouches into individual pouches is performed by a rotary knife assembly. Prior to cutting, printing indicia on the individual pouches is performed. A pattern may be printed onto the first and/or the second water-soluble film, preferably the first water-soluble film before heating. A preferred printing roller or a combination of printing rollers, each printing roller for example printing a different color on the water-soluble film. Alternatively, non-contact printing techniques can be applied. Preferably, the print is present on the inside of the water-soluble film, e.g. the side in direct conduct with the enclosed formulation. As such the print is less vulnerable to damage by external exposure such as rubbing actions or smearing action as a consequence of accidental exposure to water. Preferably, the pouches are produced with a constant pitch at a constant speed, this can facilitate the automation of the packaging process.

Preferably, in accordance with the present invention, the difference in mean thickness of the first water-soluble film and the second-water soluble film post deformation in the resulting pouch and as measured 24 hours after pouch making is less than 25%, more preferably the mean thickness in both films is in the range from about 40 to 65 μm, yet more preferably in the range of 45 to 60 μm, for ex., 45, 50, 55, 60 μm or any ranges there between. Otherwise, the mean thickness difference in the resulting pouch and as measured 24 hours after pouch making of the first water-soluble film and second-water soluble film is less than 15 μm, preferably from about 0 to 12 μm.

Also, as the top film to the bottom film ratio increases and as such the compartment comprising the first water-soluble film and the second water-soluble film becomes more symmetrical, leading to the decrease in top film actual thickness as it gets more stretched, thereby further leading to a less film residual profile at the end of a wash process in which such water-soluble pouches are utilized.

The first water-soluble film and the second water-soluble film according to the invention are preferably single layer films, more preferably manufactured via solution casting. Preferred films are made of polymeric materials. These films can be produced through methods such as casting, blow moulding, extrusion, or blow extrusion of the polymer, as commonly practiced in the industry. The first and second water-soluble films preferably include a polyvinyl alcohol polymer, which can be a polyvinyl alcohol homopolymer, an anionic polyvinyl alcohol copolymer, or a mixture of both.

The first water soluble film may comprise a first water soluble resin and the second water soluble film may comprise a second water soluble resin. In one embodiment the first water soluble resin and second water soluble resin are same. In some embodiments the first water soluble resin may be chemically different from the second water soluble resin. Preferably, the first water soluble resin comprises at least one polyvinyl alcohol homopolymer or at least one polyvinyl alcohol copolymer or a blend thereof and the second water soluble resin comprises at least one polyvinyl alcohol homopolymer or at least one polyvinyl alcohol copolymer or a blend thereof.

Preferred polymer copolymers or derivatives thereof are selected from polyvinyl alcohols, polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the polymer is selected from polyacrylates and acrylate copolymers, including polymethacrylates, methylcellulose, sodium carboxymethylcellulose, dextrin, maltodextrin, ethylcellulose, hydroxyethyl cellulose, hydroxypropyl methylcellulose,; most preferably polyvinyl alcohols, polyvinyl alcohol copolymers and/or hydroxypropyl methyl cellulose (HPMC).

The polymer may have any weight average molecular weight, preferably from about 1000 to 1,000,000, or even form 10,000 to 300,000 or even form 15,000 to 200,000 or even form 20,000 to 150,000.

The water-soluble film may comprise polyvinyl alcohol homopolymer or polyvinyl alcohol copolymer, for example a blend of polyvinylalcohol homopolymers and/or polyvinylalcohol copolymers, wherein the polyvinyl alcohol copolymers preferably are selected from sulphonated and carboxylated anionic polyvinylalcohol copolymers especially carboxylated anionic polyvinylalcohol copolymers, for example a blend of a polyvinylalcohol homopolymer and a carboxylated anionic polyvinylalcohol copolymer, alternatively a blend of two or more preferably two polyvinyl alcohol homopolymers. Alternatively, the polyvinylalcohol comprises an anionic polyvinyl alcohol copolymer, most preferably a carboxylated anionic polyvinylalcohol copolymer. In some examples water soluble films are those supplied by Monosol under the trade references M8630, M8900, M8779, M8310. In some examples the film may be opaque, transparent or translucent. The film may comprise a printed area. The area of print may be achieved using techniques such as flexographic printing or inkjet printing. The film may comprise an aversive agent, for example a bittering agent. The water-soluble film or water-soluble pouch or both may be coated with a lubricating agent.

Mixtures of polymers can also be used. This may in particular be beneficial to control the mechanical and/or dissolution properties of the compartment or pouch, depending on the application thereof and the required needs. For example, it may be preferred that a mixture of polymers is present in the material of the compartment, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

The pouch, when used herein can be of any form, shape and material which is suitable to hold the composition prior to use, e.g. without allowing the release of the composition from the pouch prior to contact of the pouched composition to water. The exact execution will depend on for example the type and amount of the composition in the pouch, the characteristics required from the pouch to hold, protect and deliver or release the compositions.

### Water-Soluble Pouch

The present invention in another aspect discloses a water-soluble pouch produced in accordance with the aforesaid process. The water-soluble pouch comprising at least one internal compartment and a substrate treatment composition. Particularly, the internal compartment comprises a first water-soluble film and a second water-soluble film shaped symmetrical or substantially symmetrical relative to a sealing plane, wherein, when multiple compartments present, at least two of the respective internal compartments are substantially of different depth. The water-soluble pouch and the water-soluble film(s) are described in more detail below.

The water-soluble pouch comprises a first water-soluble film and second water-soluble film shaped such that the pouch comprises at least one internal compartment surrounded by the first and second water-soluble film. The first water-soluble film and a second water-soluble film are sealed to one another such to define the internal compartment. The water-soluble pouch is constructed such that the substrate treatment composition does not leak out of the compartment during storage. However, upon addition of the water-soluble pouch to water, the water-soluble film dissolves and releases the contents of the internal compartment(s) into the wash liquor.

Preferably, the water-soluble pouch comprises at least one internal compartment. More preferably, the water-soluble pouch comprises at least two internal compartments and most preferably the water-soluble pouch comprises of more than two internal compartments or even more than three internal compartments. Each compartment may comprise the same or different compositions. The different compositions could all be in the same form, or they may be in different forms. Preferably all compositions are liquid detergent compositions.

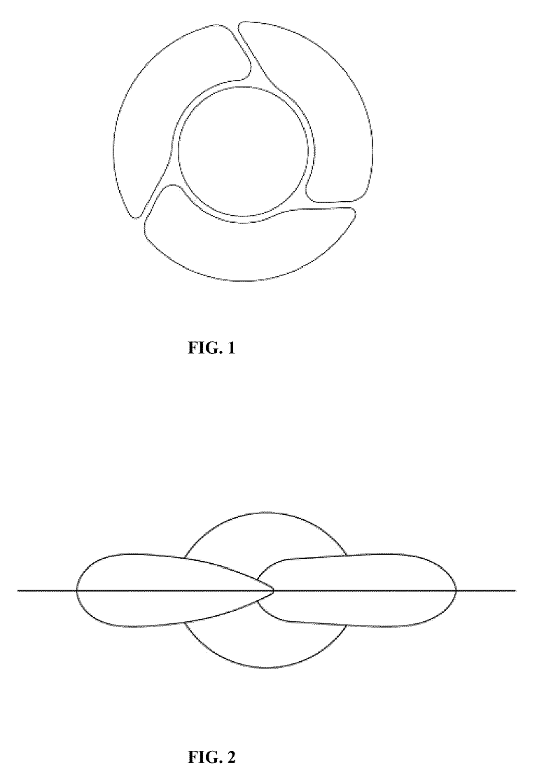

In some preferred embodiments, the compartments are arranged in a side-by-side manner on a sealing plane, and wherein the multi compartment water-soluble pouch has varying depths in at least two up to each compartment. In a preferred embodiment the Top-to-Bottom depth difference between at least two individual compartments is from 10% to 300%. Such a depth difference provides the end user a stereoscopic and contemporary appearance of the water-soluble pouch as shown in FIGS. 1 and 2.

In some preferred embodiments, each internal compartments are arranged in a side-by-side manner on a sealing plane, and wherein the first water-soluble film and the second water soluble film of every individual compartment respectively have a top and bottom films that are almost identical in shape and size, creating a uniform appearance of the top and bottom films respectively. In a most preferred embodiment the difference in mean thickness of the first water-soluble film and second-water soluble film post deformation in the resulting pouch excluding the seal area and as measured 24 hours after pouch making is less than 25%, preferably the mean thickness in both films is in the range from about 40 to 65 μm and most preferably in the range of 45 to 60 μm.

In some preferred embodiments, said multi compartments have a footprint on the sealing plane in which the footprint is round-shaped, square-shaped, oval-shaped, triangle-shaped, rectangle-shaped, or drop-shaped. Preferably, the footprint is round-shaped.

In some embodiments, the multi compartments or said at least one or more additional compartments have essentially the same shape. In some embodiments, the multi compartment are arranged in a side-by-side manner on a sealing plane and individually contain a substrate treatment composition or formulation. Preferably, the water-soluble pouch comprises a plurality of compartments in which the number of the plurality of compartments is from 2 to 15, preferably from 2 to 10, more preferably from 2 to 5, e.g. 2, 3, 4, 5, 6, 7, 8, 9, 10 and any ranges there between, and the plurality of compartments are arranged in a side-by-side manner on a sealing plane and individually contain a substrate treatment composition. In such a side-by-side manner, the water-soluble pouch is formed from two sheets of a first water-soluble film and second water-soluble film, the two sheets of film being sealed together forming a sealing web lying on a sealing plane. Preferably the water-soluble pouch consists of compartments arranged in a side-by-side configuration within a sealing plane, e.g. the water-soluble pouch not comprising any compartments in a relative superposed position.

The outer contouring seal area includes or preferably consists of a flange area. A flange area is arranged around the perimeter of the water-soluble multi compartment pouch, and the flange comprises sealed film from two, three, or more water-soluble films. Most preferably the flange comprises sealed film from two water-soluble films.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

In order to illustrate the invention more clearly, the following examples are given explaining the preferred modes of carrying it into effect and the advantageous results obtained thereby. The use of examples in no way limits the scope and meaning of the invention or of any exemplified term. Likewise, the invention is not limited to various embodiments given in this specification.

### EXAMPLES

### Inventive Examples 1, 2

The water soluble pouch produced in accordance with the present invention, has ensured reduced film residual as shown below in Table 1.

| Fabric | | Fabric | | | First water- |
|---|---|---|---|---|---|
| weight | | weight | | | soluble & Second |
| before | Dry | after | Film | Film | water-soluble |
| washing | time | washing | residual | residual | heating temp |
| (g) | (days) | (g) | (g) | (%) | difference |
| 30.98 | 1 | 34.11 | 3.13 | 15.2 | 12.5 |
| 27.19 | 1 | 29.96 | 2.77 | 13.5 | −16.3 |

### Comparative Example 1

The water soluble pouch produced in accordance with the prior state of art having a greater or huge difference in First water-soluble & Second water-soluble heating temperature, has shown greater film residual as shown below in Table 2.

| Fabric | | Fabric | | | First water- |
|---|---|---|---|---|---|
| weight | | weight | | | soluble & Second |
| before | Dry | after | Film | Film | water-soluble |
| washing | time | washing | residual | residual | heating temp |
| (g) | (days) | (g) | (g) | (%) | difference |
| 27.13 | 1 | 30.73 | 3.6 | 17.5 | 87.5 |

### Inference

It is clear from the above table 1 and 2, that the water-soluble pouch produced in accordance with the present invention having reduced First water-soluble & Second water-soluble film heating temp difference has clearly shown reduced film residue post washing and drying of fabrics.

### TEST METHOD

Produced below further is a dissolution test procedure for water-soluble pouches:

### A. Sample Preparation

### 1. Fabric Pocket Preparation

Cut a rectangle from knitted black cotton fabric with dimensions of 23.5 cm±1.5 cm by 47 cm±2 cm.
Fold the rectangle to form a square, and use an overlock stitch to prevent fraying along two sides, leaving one edge open.
Sew a blank identification label (made from flat white cotton, measuring 3 cm×3 cm) onto one side of the pocket.

### 2. Pre-Wash Weighing

Weigh the prepared fabric pocket and record this weight as (a).

### 3. Water-Soluble Pouch Preparation

Age the water-soluble pouches for a minimum of two weeks after production.
Pre-condition the aged pouches for 24 hours at 23° C. and 50% relative humidity (rH).
Weigh the pre-conditioned water-soluble pouch and record this weight as (b).

### 4. Assembly

Place the water-soluble pouch into the right back corner of the fabric pocket.
Stitch the open edge of the fabric pocket to securely close it.

### B. Test Procedure

### 1. Washing

Place all prepared fabric pockets into a Haier XQG70-HBD1426 washing machine.
Set the washing machine to a water temperature of 8° C.
After the water has been injected and the quick wash mode initiated, wash the fabric pockets for 1 minute.
Stop the quick wash program and switch to spin dry mode, spinning for 3 minutes.

### 2. Post-Wash Handling

Remove the fabric pockets from the washing machine.
Turn the fabric pockets inside out and place them in a room maintained at 20-23° C. and 30-40% rH to dry.

### 3. Post-Dry Weighing

Weigh the dried fabric pockets, including any pouch residuals, and record this weight as (c).

### 4. Data Calculation

Calculate the weight increase as (c−a).
Determine the residual percentage as ((c−a)/b).

Note that not all of the activities described above in the general description or the examples are required, that a portion of a specific activity may not be required, and that one or more further activities may be performed in addition to those described.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

The description in combination with the figures is provided to assist in understanding the teachings disclosed herein, is provided to assist in describing the teachings, and should not be interpreted as a limitation on the scope or applicability of the teachings. However, other teachings can certainly be used in this application.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for making a water-soluble pouch having at least one compartment on a sealing plane, the process comprising the steps of:
a) feeding a first water-soluble film onto a horizontal or non-horizontal portion of a continuously and rotatably moving endless surface, which comprises a plurality of moulds, and continuously moving the film to said horizontal or non-horizontal portion;
b) heating the first water-soluble film to a first water soluble film heating temperature and forming from the first heated water-soluble film on the horizontal or non-horizontal portion of the continuously moving surface, and in the moulds on the surface, a continuously moving, horizontally or non-horizontally positioned web of open pouches, by applying an under pressure;
c) filling the continuously moving, horizontally or non-horizontally positioned web of open pouches with a formulation, to obtain a web of open and filled pouches;
d) heating a second water-soluble film to a second water-soluble film heating temperature and continuously sealing the web of open pouches, by feeding the second heated water-soluble film onto the horizontally or non-horizontally positioned web of open, filled pouches, to obtain a web of closed pouches;
wherein at the point of sealing, the first water-soluble film heating temperature and the second water-soluble film heating temperature difference is in the range from 0 to 50° C., and the under pressure on the first film is released post the sealing of the second film, and;
e) cutting the web of closed pouches into a plurality of individual pouches.

2. The process according to claim 1, wherein the water-soluble pouch comprises a plurality of compartments arranged in a side-by-side manner on a sealing plane.

3. The process according to claim 1, wherein the ratio of height between the second water-soluble film to the sealing plane and between the first water-soluble film to the sealing plane of each compartment comprised in the resulting water-soluble pouch, as measured 24 hour after pouch making and stored at 20-23° C., 30-40% rH, is from 0.65 to 1.2.

4. The process according to claim 3, wherein the Top-to-Bottom depth difference between at least two individual compartments is from 10% to 300%.

5. The process according to claim 1, wherein at the point of sealing, the first water-soluble film heating temperature and the second water-soluble film heating temperature difference is from 0 to 30° C.

6. The process according to claim 1, wherein the first water-soluble film heating temperature of the first water-soluble film is in the range from 80 to 150° C.

7. The process according to claim 1, wherein the second water-soluble film heating temperature of the second water-soluble film is in the range from 30 to 175° C.

8. The process according to claim 1, wherein a first under-pressure between 200 mbar to 900 mbar is applied to the moulds after the first water-soluble film is heated and positioned over the moulds.

9. The process according to claim 1, wherein said moving endless surface is a part of a rotating platen conveyor belt having the plurality of moulds comprising vacuum holes.

10. The process according to claim 1, wherein the conveyor and/or the platens may further comprise a plurality of apertures which are located at both edges of the conveyor and/or the platens along the machine direction, in which an under pressure may be applied through the plurality of apertures.

11. The process according to claim 1, wherein the difference in mean thickness of the first water-soluble film and second-water soluble film post deformation in the resulting pouch excluding the seal area and as measured 24 hours after pouch making and stored at 20-23° C., 30-40% rH is less than 25%.

12. The process according to claim 1, wherein the sealing techniques include but are not limited to heat sealing, solvent sealing, and a combination thereof.

13. The process according to claim 12, wherein the second water-soluble film is wetted by spraying a solvent such as water on or contacting a solvent-containing article with the second water-soluble film.

14. The process according to claim 13, wherein the heat sealing is used, wherein a sealing roller with cavities of the size of the part of the pouch, which is not enclosed by the mould, is rolled over the web of pouches, passing under the roller such that the roller contacts only the area which is to be the sealing area, namely between the moulds, around the edges of the moulds.

15. The process according to claim 1, wherein the first water-soluble film and the second water-soluble film are heated to their film temperatures by using an infrared lamp such as infrared quartz tube lamps, a heating plate, or a combination thereof.
